(19) United States
(12) Patent Application Publication
(10) Pub. No.: US 2013/0110483 A1
(43) Pub. Date: May 2, 2013

(54) METHOD FOR MEASUREMENT SCREENING UNDER RESERVOIR UNCERTAINTY

(71) Applicants: NIKITA V. CHUGUNOV, ARLINGTON, MA (US); TERIZHANDUR S. RAMAKRISHNAN, BOXBOROUGH, MA (US)

(72) Inventors: NIKITA V. CHUGUNOV, ARLINGTON, MA (US); TERIZHANDUR S. RAMAKRISHNAN, BOXBOROUGH, MA (US)

(21) Appl. No.: 13/286,040

(22) Filed: Oct. 31, 2011

(51) Int. Cl. G06G 7/48

(52) U.S. Cl. 703/10

(57) ABSTRACT

A method for quantifying uncertainty in a subterranean formation quality including calculating a plurality of values of a property of an individual block of a grid, calculating a probability of the property in the block, distributing the property and probability of the blocks onto a map, and performing a service on a formation wherein the service comprises information in the property and probability-map. A method for quantifying uncertainty in a subterranean formation quality including calculating a property of an individual block of a grid, calculating a probability of the property of the block, establishing a block value as a representation of a probability resolution, calculating the probability of the block value, distributing the block value and the block value probability onto a map, and performing a service on a formation wherein the service includes information in the map. A well position may be included in the calculation of a block property.

### FIELD

The general field of invention relates to quantification of uncertainty in reservoir performance. The main source of uncertainty is often due to limited available information about the reservoir properties such as porosity, permeability and their spatial distribution, lithology and multiphase flow characteristics.

### BACKGROUND

Predictive reservoir simulations, based upon which decisions are routinely made, are rarely definitive. More often than not, data are either sparse, or of such a low resolution and of a low information content that uncertainties in the outcomes must be estimated. For carbon sequestration, uncertainty quantification is important.

Physically consistent uncertainty quantification and propagation allows one to quantify uncertainty in the performance of the underground reservoir targeted for geological storage of CO₂. The reservoir performance is formalized through specific quantities referred to as performance metrics. If the uncertainty in the predicted values of the performance metric is not within acceptable limits to make a decision, a special quantitative method (such as global sensitivity analysis based on Sobol decomposition of the variance) is used to identify and rank uncertain input parameters of the underlying reservoir model that have the largest contribution to the uncertainty (variance) of the predicted performance metric.

Uncertainty analysis for reservoir performance usually involves running hundreds of reservoir simulations. The outputs of the reservoir simulator may include fluid saturations, compositions, pressures, temperature and other physical properties of interest at every grid block of the reservoir model. It may also be an integral representation of the physical and chemical quantities e.g., over a surface or a curve. Furthermore, outputs may include wellbore related to performance such as water-cut, gas-cut, phase transitions, and total flow-rate. It is not uncommon for a typical reservoir to be represented by thousands to several millions of grid cells. As a result, vast amount of data is generated. In the absence of the efficient visualization and analysis tools, only a small subset of the generated data is used for subsequent decision-making. Conveying vast data and its uncertainty is particularly important for enabling informed decisions with regard to acquiring future data so as to reduce future uncertainties.

At every stage of a CO₂ storage project, performance and risk metrics such as containment, injectivity, and displacement efficiency, are important assessments that should be used in decision-making. To a large extent, expectations in performance metrics and their uncertainty quantification depend on the petrophysical characterization of the storage site. Site characterization is normally conducted from the very early stages of the project and refined continuously as more data become available.

By nature, well-known geostatistical methods should rely upon large amounts of statistical information with regard to both single and multiphase flow properties of the rock within a given lithology. Unfortunately, whilst single-phase flow behavior may be estimated over large numbers of samples, multiphase flow properties are time consuming to acquire and are error prone even in the laboratory. Furthermore, procuring formation samples along a given lithology away from a wellbore is prohibitive and is virtually impossible with currently available technology.

It is for the above-mentioned reasons that it is important to have a reasonable basis for incorporating statistical inputs that are based on petrophysical sciences, and which honor log and seismic data within the context of their own measurement specifications. It is also desirable that these methods are able to construct two-phase flow properties and their statistical variation at all locations of relevance. Geostatistical methods are ill-suited for this purpose, because of i) unavailability of statistics away from the wellbore, and ii) impracticality of acquiring the data required to carry out predictive multiphase flow calculations.

### SUMMARY OF THE INVENTION

Embodiments relate to a method for quantifying uncertainty in a subterranean formation quality including calculating a plurality of values of a property of an individual block, calculating a probability of the property of the block, distributing the property and probability of the block properties into a map, and performing a service on a formation wherein the service comprises information in the property and the probability-map. Embodiments also relate to a method for quantifying uncertainty in a subterranean formation state such as pressures and saturations, including calculating a property of an individual block of a grid, calculating a probability of the property of the block, establishing a block value as a representation of a probability resolution, calculating the probability of the block value, distributing the block value and the block value probability into a map, and performing a service on a formation wherein the service includes information in the map. A well position may be included in the calculation of a block property. Embodiments also relate to a method for quantifying uncertainty in a subterranean formation response including calculating a property of an individual block of a grid, calculating a probability of the property of the block, establishing a block value probability, calculating a block value based on the block value probability, distributing the block value and the block value probability into a map, and distributing the values of the response and performing a service on a formation or the response wherein the service includes information in the map.

### BRIEF DESCRIPTION OF THE DRAWINGS

Embodiments are further explained in the detailed description that follows, in reference to the noted plurality of drawings by way of non-limiting examples of exemplary embodiments of the present invention. The patent or application file contains at least one drawing executed in color. Copies of this patent or patent application publication with color drawing will be provided by the Office upon request and payment of the necessary fee.

FIG. 1. Probability-map of Type 1 for CO₂ saturation after three years of injection. The color-map indicates the probability that CO₂ is present (i.e., S_{CO2}>0.05) at a given point within reservoir.

FIG. 2. Probability-map of Type 2 for pressure increase in the reservoir after one month of CO₂ injection. The estimated pressure change corresponds to 80% probability (P80) that the pressure increase at a given grid block within the reservoir is at least of the value represented by the color-map with a range from zero to five psi.

FIG. 3. Probability-map of Type 3 for monitoring well after three years of injection and measurement screening chart for CO₂ saturation sampling. The square markers indicate positions of the sampling stations in the monitoring well.

FIG. 4. Cumulative probability distribution function for CO₂ saturation at a particular depth at the monitoring well. Dotted lines represent threshold values corresponding to the sensitivities of measurements M1, M2, and M3. Measurement M1 has a high probability of success; measurement M3 has a very low probability of success. Uncertainty in the predicted success of measurement M2 might be too high to make a conclusive decision.

It will be recognized by the person of ordinary skill in the art, given the benefit of this disclosure, that certain dimensions, features, components, and the like in the figures may have been enlarged, distorted or otherwise shown in a non-proportional or non-conventional manner to facilitate a better understanding of the technology disclosed herein.

### DETAILED DESCRIPTION OF THE INVENTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems, processes, and other elements in the invention may be shown as components in block diagram form in order not to obscure the embodiments in unnecessary detail. In other instances, well-known processes, structures, and techniques may be shown without unnecessary detail in order to avoid obscuring the embodiments.

Also, it is noted that individual embodiments may be described as a process depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or routine or the main program.

Furthermore, embodiments may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor or processors may perform the necessary tasks.

Quantification of uncertainty in reservoir performance helps with reservoir planning and maintenance. The main source of uncertainty is often due to limited available information about the reservoir properties such as porosity, permeability and their spatial distribution, lithology and multiphase flow characteristics. This uncertainty is propagated through the underlying reservoir model(s). The subsequent business decisions are made based on the predicted performance of the reservoir. The illustrating examples herein include geological storage of CO₂ and enhanced oil recovery (EOR) operations with particular focus on project screening, and design and evaluation of the monitoring program under reservoir uncertainty.

### Probability Maps of Type 1 and Type 2.

In the first part of this disclosure, we describe a method to generate variations of the probability-map comprising an efficient analysis and visualization tool that allows one to compactly represent uncertainty of a given property.

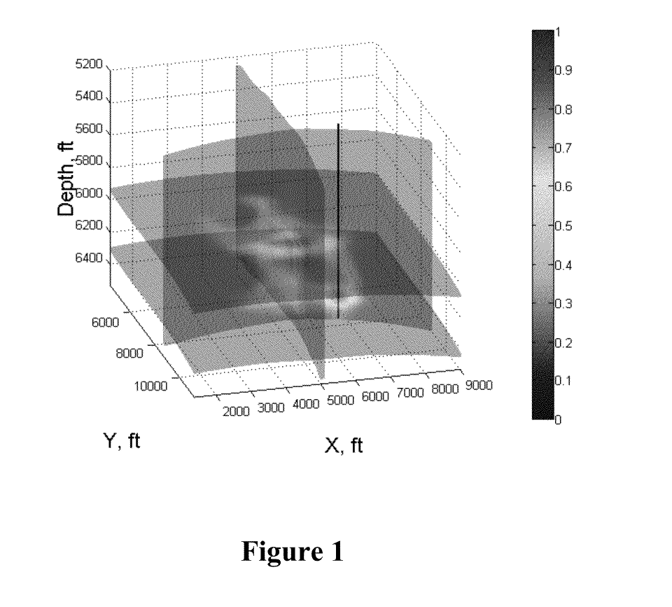

FIG. 1 shows a probability-map of CO₂ saturation for the CO₂ storage project at Mt. Simon sandstone reservoir with a planned injection of one Mt of CO₂ over three years. The color-map indicates the probability that CO₂ is present (i.e., S_{CO2}>0.05) at a given point within reservoir. This probability-map represents uncertainty in the spatial plume extent at the end of the project (100 years), and is generated based on 200 ECLIPSE™ 3D simulations (commercially available from Schlumberger Technology Corporation of Sugar Land, Tex.) with almost one million grid cells each. The map illustrates the expected plume migration from the injection well (indicated by the black vertical line) to the north/northwest, following the dipping structure of the reservoir.

This type of the probability-map (Type 1) is generated by performing the following steps:
Generate N physically, implying also petrophysically, consistent realizations of the reservoir model. One of the methods to accomplish this is disclosed in United States Patent Application Publication Number 20100299126, which is incorporated by reference herein in its entirety. The value of N is typically in hundreds to ensure that the generated realizations sufficiently represent all possible realizations of the reservoir model for given data about the reservoir.
Perform N reservoir simulations and store the outcomes on a storage device. The outcomes may include both cumulative quantities such as total amount of the dissolved CO₂ in the reservoir; local quantities such as wellhead pressure; and spatially distributed quantities such as pressure or CO₂/H₂O saturations' output for every individual grid block of the model.
For a given physical property, at every grid block there are N possible (non-unique) values that represent probability distribution of a given property in a given grid block.
Based on the obtained probability distribution and a specified threshold value of a physical property (0.05 for CO₂ saturation in the case presented in FIG. 1), the probability of having a value of a given physical property at or above the threshold value is calculated individually at every grid block of the reservoir model.
In an embodiment, the calculated probabilities are then presented according to the color-map from zero (blue in FIG. 1) to one (red in FIG. 1). Special cases for vertically and laterally averaged two-dimensional CO₂ saturation probability contour plots were previously discussed in United States Patent Application Publication Number 20100299126, which is incorporated by reference herein in its entirety.

Potential applications of such a representation for geological storage of CO₂ include analysis of probability of CO₂ migrating outside of the property boundaries, and probability of CO₂ being detected at a specific location for a given sensitivity of the measurement (with the threshold value of CO₂ saturation adjusted accordingly). Among potential oilfield applications, the estimation of the sweep efficiency in water-alternating-gas enhanced-oil-recovery (WAG EOR) operations under reservoir uncertainty based on the probability-maps for CO₂/H₂O/oil saturations is described herein. In waterflood projects, H₂O saturation probability-map can be used to analyze the uncertainty in water migration and identifying the zones where the oil is being by-passed.

In another embodiment, we emphasize that the probability-map may be generated for any physical property of interest. For example, one can generate the probability-map for uncertainty in pressure increase above certain value so that the Area of Review could be delineated according to the US EPA proposed regulations for geological CO₂ storage. Alternatively, one can generate the probability-map for pressure reaching or exceeding a specified threshold value in order to identify and evaluate fracturing risk within the reservoir or the cap rock.

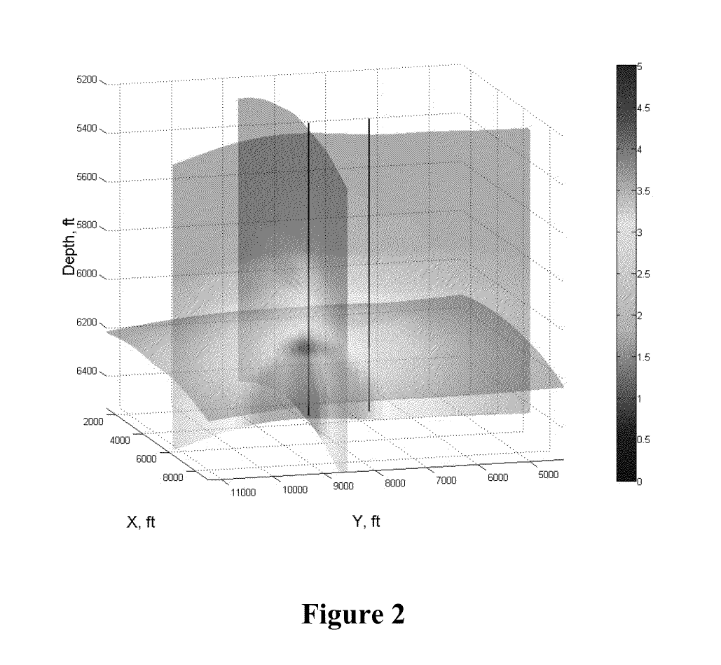

In yet another embodiment, the Type 2 probability-map can be generated according to a given probability P_{X} or confidence level. Type 2 probability-map can be generated based on the following procedure:
Generate N physically consistent realizations of the reservoir model. One of the methods to accomplish this is disclosed in United States Patent Application Publication Number 20100299126, which is incorporated by reference herein in its entirety. The value of N is typically of the order of hundreds to ensure that generated realizations sufficiently represent all possible realizations of the reservoir model given available data about the reservoir.
Perform N reservoir simulations and store the outcomes on a storage device. The outcomes may include both cumulative quantities such as total amount of the dissolved CO₂ in the reservoir; local quantities such as wellhead pressure; and spatially distributed quantities such as pressure or CO₂/H₂O saturations' output for every individual grid block of the model.
For a given physical property, at every grid block there are N possible (non-unique) values that represent probability distribution of a given property in the given grid block.
Based on the obtained probability distribution and a specified probability P_{X} for a given physical property (80% probability for pressure in the case presented in FIG. 2), the value of a given physical property corresponding to the probability P_{X} at every grid block of the reservoir model is obtained.
In one embodiment, the calculated values are then presented according to the color-map from minimum (blue in FIG. 2) to maximum (red in FIG. 2).

For example, FIG. 2 shows the probability-map generated for pressure increase in the reservoir after one month of CO₂ injection. The estimated pressure change corresponds to 80% probability (P80) that the pressure increase at any grid block within the reservoir is at least of the value represented by the color-map with a range from zero to five psi. Several useful interpretations of this map are possible. Given the threshold value for a fracture pressure, this type of a map indicates the zones where the fracture pressure will be exceeded with a given probability. Another interpretation of this map is related to the evaluation of the monitoring program at the offset monitoring well (shown in FIG. 2 approximately 1000 ft to the right of the injection well). The color-map indicates the pressure changes seen by a properly designed monitoring well for a given level of confidence (80% in case shown in FIG. 2). This information can be used to assess the success of a pressure monitoring program and advantageously to determine the timing and location of the measurements.

The map representing the mean (expected) values of a given property for every block of the reservoir model is a special case of the probability-map of Type 2. This special case of the mean probability-map is also generally different from the P50 probability-map.

### Probability Maps for Geophysical Measurements Interpretation

The importance of petrophysically consistent uncertainty quantification in reservoir performance is extended to generate petrophysically consistent probability-maps for physical properties that are used to interpret geophysical and petrophysical measurements such as seismic, electromagnetic, acoustic, nuclear, gravity, etc.

Predictions of the measurement responses are usually used to design the monitoring program. These predictions are based on the forward modeling of a specific tool whose inputs necessarily include prediction of the petrophysical or geophysical properties (e.g., density and acoustic velocities for seismic measurements, electrical conductivity for electromagnetic surveys, etc.) of the formations and fluids that are not directly calculated by traditional reservoir simulators. Calculation of these geophysical properties should be done during the uncertainty propagation step for each realization of the reservoir model as opposed to the post-processing step after the statistics of the reservoir performance is calculated.

For example, the electrical conductivity is typically computed based on the Archie's equation: σ=σₐ(ψ)Sₐⁿφ^{m}, where σₐ is a conductivity of an aqueous phase that depends on salinity ψ, Sₐ is a saturation of an aqueous phase, φ is porosity, m is a cementation exponent, and n is a saturation exponent. The conductivity profile for a given realization of a reservoir model should be calculated using salinity and saturation profiles computed for this realization and φ, m, and n corresponding to this realization. The probability-map for conductivity-based measurements is then generated by analyzing statistics of the tool responses generated for individual conductivity profiles calculated for each realization of the reservoir model. An alternative post-processing approach when conductivity is calculated by independent sampling from obtained probability distributions of salinity, saturation profiles and porosities will produce petrophysically inconsistent results since all spatial conditional probability distributions and correlations arising from the reservoir simulations are practically intractable.

Another example of petrophysically consistent probability-map generation is related to acoustic velocities—compressional wave velocity Vₚ and shear wave velocity Vₛ—key components for prediction and interpretation of seismic and acoustic measurements. A traditional approach to calculate effective acoustic velocity of a porous medium filled with various fluids involves using fluid substitution models. In an embodiment, for each realization of the reservoir model, the spatial distribution of porosity, fluid saturations, pressures, temperatures, and formation elastic properties are used to calculate corresponding spatial distribution of Vₚ and Vₛ values. Once this calculation is done for every realization, the computed Vₚ and Vₛ statistics may be used to generate probability-maps of Type 1 or Type 2. Petrophysically consistent uncertainty quantification in acoustic velocities will be a key input for designing the seismic surveys to identify and illuminate the most uncertain areas of the reservoir using methodology disclosed by M. Khodja, M. Prange, H. Djikpesse. Guided Bayesian Optimal Experimental Design: Inverse Problems, 26, No. 5, pp. 1-20, 2010, which is incorporated by reference herein. These probability-maps can be used to identify optimal location of the monitoring well (e.g., for cross-well monitoring design) and timing and position of the measurements (e.g., source-receiver pairs) in the monitoring well as discussed below.

### Probability Maps for Monitoring Well.

The probability-map of Type 1 or Type 2 can be generated at any time during the life of the project for any point or line or plane within the reservoir. Therefore, the probability-map can be utilized to optimally place the monitoring well or study the uncertainty in the cross-well responses.

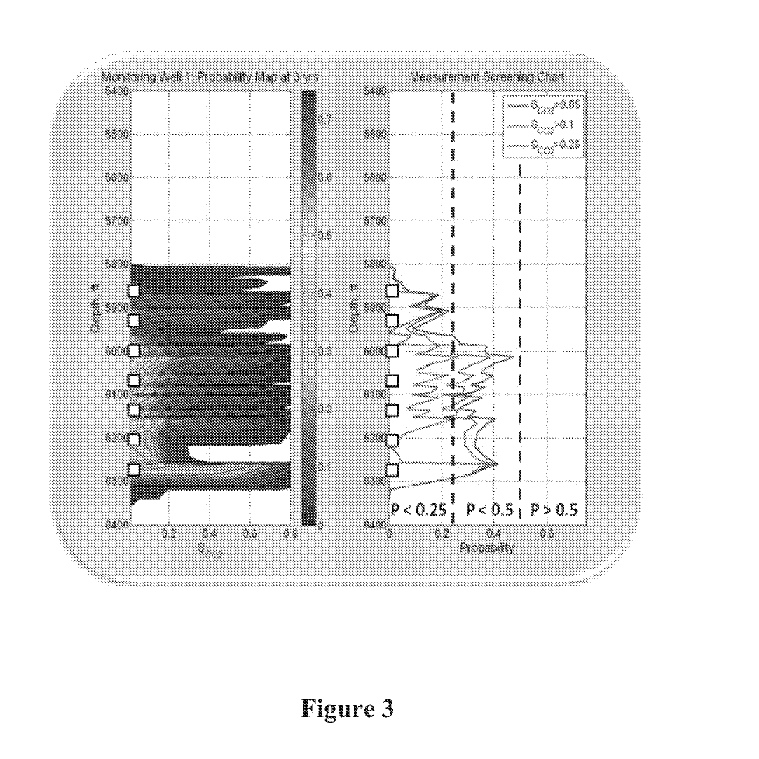

Alternatively, if the location of the monitoring well is already given, one can evaluate the probability of a measurement success at any particular depth along the well, as shown in FIG. 3. Type 3 (well-centric) probability-map is derived from a series of probability-maps of Type 1 generated for a plurality of reservoir model grid blocks corresponding to the position of the monitoring well and a full range of possible values of a given physical quantity, such as CO₂ saturation in the range between zero and one. The plot on the left shows a probability-map of Type 3 generated for the CO₂ saturation in the monitoring well after three years since the start of injection. The monitoring well is located approximately 1000 ft north (direction y) of the injection well in the up-dip direction according to local stratigraphy. The y-axis shows the depth along the monitoring well. The square markers along the y-axis indicate positions of the sampling stations in the monitoring well. The x-axis shows CO₂ saturation. The color-map indicates the probability of CO₂ being present at the given depth at the monitoring well with a saturation values above the corresponding value at the x-axis. For example, selecting a value of 0.2 for CO₂ saturation in the x-axis, one can see that there is a probability of 40% to have it appear at the monitoring well at depth of 6260 ft, and a probability of 20 to 25% for several zones above it.

The graph on the right in FIG. 3 shows a simplified version of this plot and provides a basis for screening the measurements. If one takes a vertical slice for a given value of the x-axis (CO₂ saturation, in this case), one will obtain the probability of having CO₂ at this given value (or higher) along the monitoring well. Given the sensitivity of various tools to CO₂ saturation, one can use this plot as a screening tool to identify specific measurements and specific depths where these measurements will have a higher probability of detecting CO₂. For example, if a fluid sampling tool can detect presence of CO₂ with saturation of 0.05 and greater, the blue line shows that the sampling depths of 6010 ft, 6050 ft, 6160 ft, and 6270 ft will have the highest probability (around 40%) of this tool detecting CO₂ along the monitoring well at the end of the injection period of three years. Should another tool with the threshold sensitivity of 0.25 for CO₂ saturation be considered, the red line clearly shows that only sampling at depth of 6270 ft will have a relatively high probability of success (almost 40%) with all other depths not exceeding 25% probability of success.

Most measurements infer CO₂ saturations indirectly. Therefore, the measurement screening plot should be derived from the probability-map generated for a particular physical quantity measured by a given tool. For example, a time-lapse neutron capture cross-section is often used to infer CO₂ saturation and can be measured by the tool with a neutron generator and gamma ray detectors. Reservoir Saturation Tool (RST™ commercially available from Schlumberger Technology Corporation of Sugar Land, Tex.) is an example of sigma cross-section measurement tool. In one embodiment, a probability-map for sigma cross-section (Σ) is generated following the procedure disclosed in Section 2. The values of Σ will depend on salinity of the brine occupying the pore space, brine saturation, porosity and lithology of the formation. The lithology effects can be eliminated if the interpretation is conducted in a time lapse mode. A measurement screening plot similar to the one shown in FIG. 3 can be generated to evaluate the probability of time lapse Σ measurement exceeding the accuracy of the tool in a given environment.

Similar evaluations may be carried out for pressure, temperature or well-to-well interference crossing a threshold sensitivity of a corresponding measurement at any moment during the life of the project.

Well-centric (Type 3) probability-maps can also provide useful information for the completion design of the well. For example, the CO₂ saturation probability-map shown in FIG. 3 can be used to predict not only the zones where CO₂ is likely to be present, but also the zones where CO₂ is unlikely to appear. Presence of CO₂ and water create unfavourable environment for traditional Portland cements and requires a special composition to be used in cement mix to ensure resistance to CO₂. Once it is established that CO₂ is unlikely to appear in the zones above certain depth along the injection or the monitoring well, the completion design of the well can be optimized accordingly to deploy CO₂ resistant cement in the zones likely to have CO₂ and water present simultaneously during the life of the project.

In another embodiment, Type 3 probability-map generated for values of pressure or temperature corresponding to the limits of operation can be used in predicting the probability of failure for a particular hardware installed in the wellbore.

### Reducing Uncertainty in Monitoring Program Design

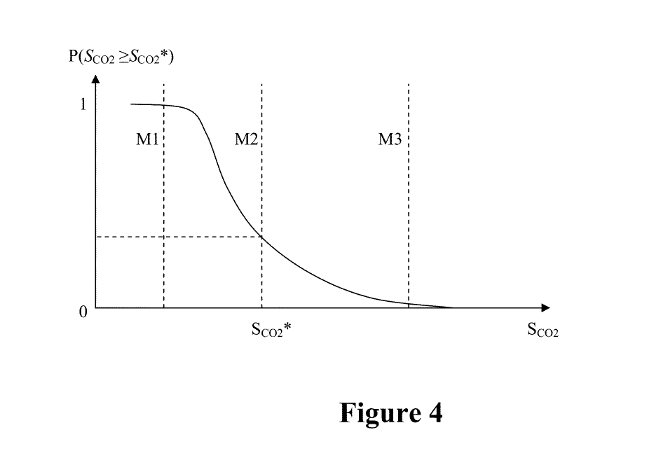

The probability-map of Type 3 for the monitoring well can be also used to evaluate the uncertainty in the measurement prediction and devise a targeted characterization program to reduce this uncertainty. The procedure disclosed below is applied for CO₂ saturation estimate, although this by no means is limited to this application:
Evaluate the uncertainty in the predicted value of CO₂ saturation being detected at a specific depth and generate cumulative probability function plot (FIG. 4).
Estimate probability of the CO₂ saturation exceeding the threshold value corresponding to a particular measurement sensitivity (S_{CO2}*). In the example shown in FIG. 4, the probability of measurement success for measurement M1 is close to unity, whereas the probability of measurement success for M3 is close to zero.
If the predicted uncertainty in the particular measurement is too high to make a conclusive decision (e.g., M2 in FIG. 4), apply global sensitivity analysis to identify the key petrophysical properties of the reservoir whose uncertainties have the most effect on the uncertainty of the measurement prediction. An algorithm disclosed in paragraphs 0068-0071 of United States Patent Application Publication Number 20100299126 (incorporated above) can be used to calculate first order sensitivity indices to quantify the contribution of the uncertainty in the given petrophysical property to the uncertainty in the prediction of a given physical measurement at a given location.
Rank petrophysical properties according to the calculated sensitivity indices.
Identify measurements for a subsequent reservoir characterization program targeting the ranked petrophysical properties to reduce uncertainty (variance) in the predicted outcome of the monitoring program.

Once the uncertainty in measurement prediction is reduced to an acceptable level, the zones with higher variance in prediction can be selected to perform the measurement.

We have disclosed a method to evaluate and identify the petrophysical or geophysical measurements that will have the highest probability of success under given uncertainty in reservoir model. The reservoir uncertainty is propagated through the models and represented in the form of 2D or 3D probability-maps. We have disclosed the procedure to generate probability-maps of Type 1 and Type 2 for a given quantity. A special case of the probability-map for a monitoring well (Type 3) is discussed and is shown to be useful to provide uncertainty estimates for designing monitoring and sampling program including the tools to be deployed, the depths of the measurement, and the measurement schedule. If the predicted uncertainty in the particular measurement is too high to make a conclusive decision, a global sensitivity analysis approach is used to identify the key petrophysical properties of the reservoir whose uncertainties have the most effect on the uncertainty of the measurement prediction. A subsequent reservoir characterization program targeting the identified petrophysical properties may thus be designed and carried out to reduce uncertainty in the predicted outcome of the monitoring program.

Possible applications of this technique include the following.
1. CO₂ storage project screening based on containment (probability of CO₂ plume migration outside the project boundaries) and cost (area of review and area/cost of monitoring).
2. Evaluation of the monitoring well location and measurement for the single well monitoring program (including but not limited to RST, gravity, resistivity, pressure, composition from sampling etc.) based on the probability of success (predicted signal exceeds the sensitivity threshold of a measurement).
3. Identifying the location of the well and the measurements based on the value for reservoir characterization (e.g., based on the predicted variance of the measurement).
4. Analysis of sweep efficiency in EOR projects based on CO₂/H₂O/oil saturation probability-maps.
5. Design of the cross-well monitoring programs based on physically consistent probability-maps (e.g., pressure, acoustic, conductivity).
6. Design of the surface to borehole monitoring program.
7. Design of seismic and electromagnetic 3D and 4D surveys where the first three dimensions are spatial and the fourth temporal.

There have been described and illustrated herein several embodiments of methods for quantifying and analyzing uncertainty related to simulating fluid flow within an underground formation. While particular embodiments of the invention have been described, it is not intended that the invention be limited thereto, as it is intended that the invention be as broad in scope as the art will allow and that the specification be read likewise. Thus, while particular simulation tools have been disclosed, it will be appreciated that other simulation tools could be used as well. Likewise, while certain tools have been disclosed for obtaining data from which input parameters to the simulation model can be generated, it will be appreciated that other tools could be utilized. It will therefore be appreciated by those skilled in the art that yet other modifications could be made to the provided invention without deviating from its spirit and scope as claimed.

What is claimed is:

1. A method for performing an oilfield operation, comprising:
calculating a plurality of values for a property of an individual block within a grid;
calculating a probability of the property of the block;
distributing the block property and its probability onto a map; and
performing a service on a formation wherein the service comprises information in the property and the probability-map.

2. The method of claim 1, wherein the map indicates probability of the property value exceeding a specified threshold value.

3. The method of claim 1, wherein the map indicates the property value corresponding to a specified probability threshold.

4. The method of claim 1, wherein the oilfield operation is selected from the group consisting of CO₂ sequestration, enhanced oil recovery, and oil and gas production.

5. The method of claim 1, wherein the map is generated for a plurality of blocks comprising at least one selected from a group consisting of a reservoir, a surface, and a well.

6. The method of claim 1, wherein the property is a predicted measurement response calculated from the group of physical properties consisting of density, resistivity or conductivity, pressure, temperature, saturation, concentration, nuclear capture cross-section, and acoustic velocities.

7. The method of claim 1, wherein the service is selected from the group consisting of evaluating and identifying the location of a monitoring well, evaluating and designing the completion of a monitoring well.

8. The method of claim 1, wherein the probability encompasses a property wherein the signal exceeds the sensitivity threshold of a measurement of the property.

9. The method of claim 6, wherein the probability encompasses a property wherein the signal exceeds the operational limit of the hardware.

10. The method of claim 1, further comprising evaluating and designing a monitoring program.

11. The method of claim 10, further comprising a cross-well or surface to borehole monitoring program.

12. A method for performing an oilfield operation, comprising:
evaluating an uncertainty of a predicted measurement value of a block in a grid;
estimating a probability that the predicted measurement value exceeds a threshold value;
applying a global sensitivity analysis to the estimated probability value in the blocks of the grid;
identifying a reservoir property that influences the estimated uncertainty using the analysis; and
performing a service on a formation wherein the service comprises information in the grid.

13. The method of claim 12, wherein the identifying the property comprises quantifying a contribution of the property to the estimated uncertainty.

14. The method of claim 12, wherein the service comprises the measurement of the identified reservoir property.

15. The method of claim 12, further comprising using the reservoir property in a reservoir characterization program.

16. The method of claim 12, wherein the operation comprises CO₂ storage, well monitoring, well location placement, sweep efficiency analysis, or surface to borehole monitoring.
